(19) United States
(12) Patent Application Publication
(10) Pub. No.: US 2016/0091006 A1
(43) Pub. Date: Mar. 31, 2016

(54) FIXING ASSEMBLY AND FIXING DEVICE

(71) Applicant: HON HAI PRECISION INDUSTRY CO., LTD., New Taipei (TW)

(72) Inventors: TZU-WEI LAI, New Taipei (TW); CHING-JOU CHEN, New Taipei (TW)

(21) Appl. No.: 14/543,579

(22) Filed: Nov. 17, 2014

(30) Foreign Application Priority Data
Sep. 30, 2014 (CN) 201410517361.3

(51) Int. Cl. F16B 5/02

(52) U.S. Cl. CPC F16B 5/02

(57) ABSTRACT

A fixing assembly includes a first mounting part, a second mounting part, a fastener and a screw. The second mounting part defines a hole. The first mounting part includes a connecting portion. The fastener includes a stopper portion and a fixing end. The fixing end extends from the stopper portion. The fixing end includes a resisting portion and a fixing part. The connecting portion is fixed with the stopper portion. The fixing part passes through the hole and engages with the screw. The first mounting part and the second mounting part are fixed in the two ends of resisting portion.

### CROSS-REFERENCE TO RELATED APPLICATIONS

This application claims priority to Chinese Patent Application No. 201410517361.3 filed on Sep. 30, 2014, the contents of which are incorporated by reference herein.

### FIELD

The subject matter herein generally relates to fixing devices with fixing assemblies.

### BACKGROUND

Electronic devices include a plurality of circuit boards. The circuit boards need to be fixed to an enclosure of the electronic device. However, the circuit boards need to be spaced from the enclosure for preventing leakage and short circuits.

### BRIEF DESCRIPTION OF THE DRAWINGS

Implementations of the present technology will now be described, by way of example only, with reference to the attached figures.

FIG. 1 is an exploded, isometric view of one embodiment of a fixing assembly.

FIG. 2 is another exploded, isometric view of the fixing assembly of FIG. 1.

FIG. 3 is an assembled view of the fixing assembly of FIG. 1.

FIG. 4 is a cross sectional view of a fixing assembly taken along line IV-IV of FIG. 3.

FIG. 5 is an exploded, isometric view of another embodiment of a fixing assembly.

FIG. 6 is an assembled view of the fixing assembly of FIG. 5

FIG. 7 is a cross sectional view of a fixing assembly taken along line VII-VII of FIG. 6.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

The present disclosure is described in relation to a fixing assembly.

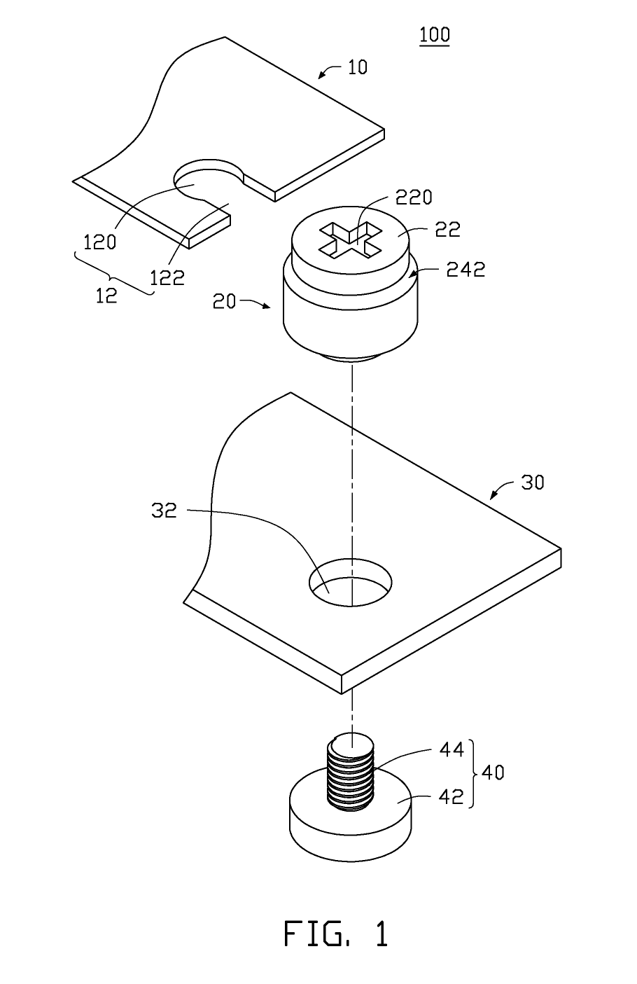

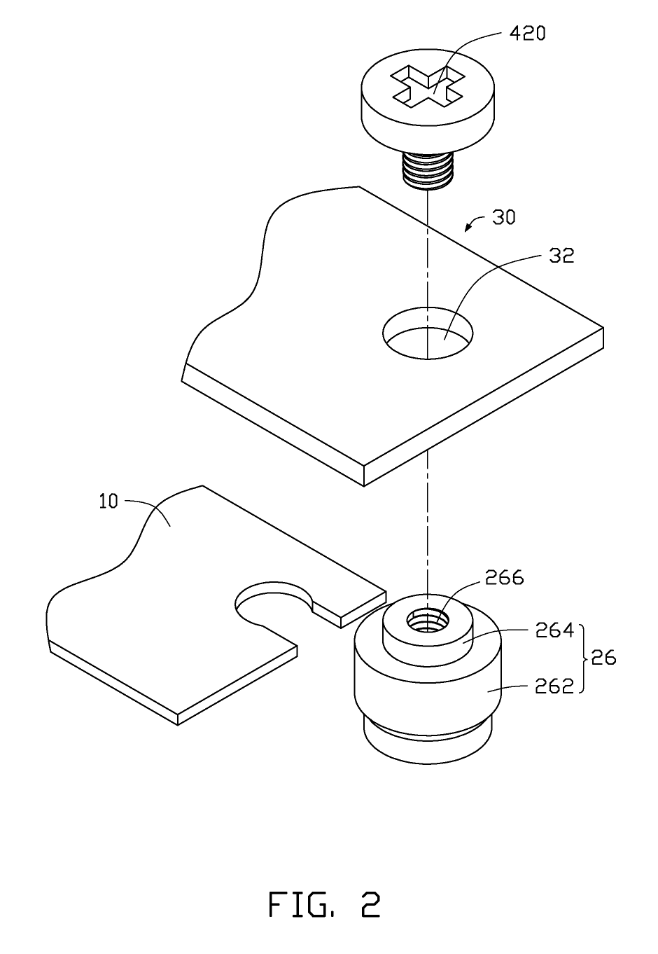

FIGS. 1 and 2 illustrate one embodiment of a fixing assembly 100 for fixing and spacing circuit boards. The fixing assembly 100 includes a first mounting part 10, a fastener 20, a second mounting part 30, and a screw 40.

The first mounting part 10 defines a connecting portion 12. In at least one embodiment, the connecting portion 12 is located at an edge of the first mounting part 10. The connecting portion 12 defines a connecting hole 120 and a guide groove 122. The connecting hole 120 communicates with the guide groove 122. In at least one embodiment, the connecting hole 120 is substantially arc-shaped and the guide groove 122 is substantially rectangular. A width of the guide groove 122 is less than a diameter of the connecting hole 120. The guide groove 122 extends to the edge of the first mounting part 10.

The fastener 20 includes a first operation end 22, a stopper portion 24, and a fixing end 26. The stopper portion 24 extends from the first operation end 22. The fixing end 26 extends from the stopper portion 24. The stopper portion 24 is located between the first operation end 22 and the fixing end 26. The first operation end 22 defines a first operation part 220. In at least one embodiment, the first operation part 220 is cross-shaped. The first operation end 22, the stopper portion 24, and the fixing end 26 are substantially cylindrical. A diameter of the stopper portion 24 is less than diameters of the first operation end 22 and the fixing end 26, to form a latching slot 242. The stopper portion 24 can be elastic. The diameter of the stopper portion 24 is less than a diameter of the connecting hole 120 but greater than the width of the guide groove 122. The fixing end 26 includes a resisting portion 262 and a fixing part 264. The fixing end 26 also defines a mounting hole 266. The fixing part 264 extends from the resisting portion 262. In at least one embodiment, the resisting portion 262 and the fixing part 264 are substantially cylindrical. A diameter of the fixing part 264 is less than a diameter of the resisting portion 262. The mounting hole 266 extends from the fixing part 264 to an interior of the resisting portion 262. The mounting hole 266 is a threaded hole. The fastener 20 is integrally formed.

The second mounting part 30 defines a hole 32. The diameter of the hole 32 is at least equal to the diameter of the fixing part 264. A diameter of the hole 32 is less than a diameter of the resisting portion 262.

The screw 40 includes a second operation end 42 and a fixing column 44. The fixing column 44 extends from the second operation end 42. The second operation end 42 includes a second operation part 420. In this embodiment, the second operation part 420 is cross-shaped. The fixing column 44 can include an external thread.

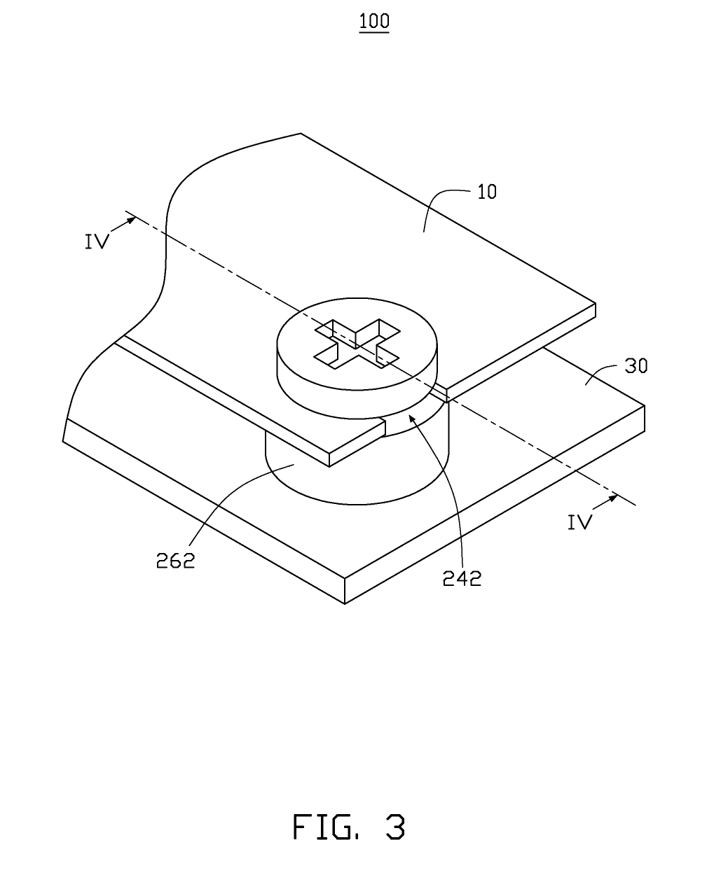

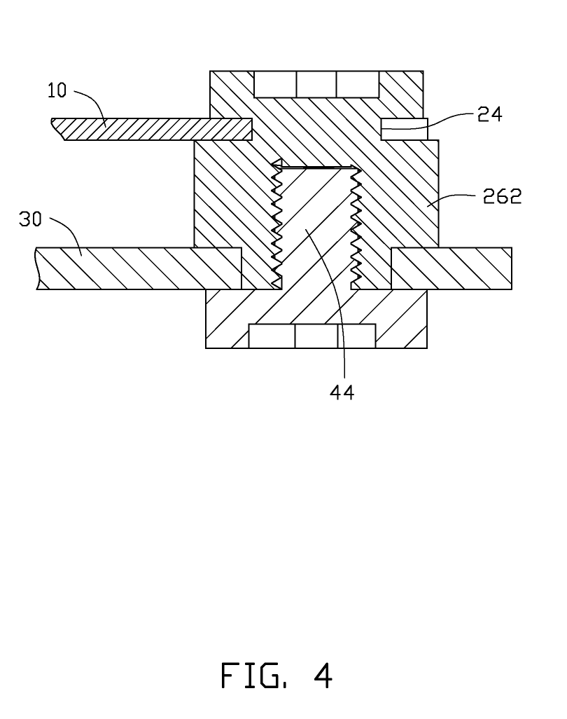

FIGS. 3 and 4 show two views of the assembled fixing assembly 100. In assembly, the stopper portion 24 of the fastener 20 slides into the connecting hole 120 from the guide groove 122 of the first mounting part 10. The stopper portion 24 is squeezed by the edge of the guide groove 122 because the diameter of the stopper portion 24 is greater than the diameter of the guide groove 122. The stopper portion 24 restores to a full size in the connecting hole 120 because the diameter of the stopper portion 24 is less than the diameter of the connecting hole 120. The first mounting part 10 is mounted in the latching slot 242 of the fastener 20. The fixing part 264 of the fastener 20 extends through the hole 32 of the second mounting part 30. The fixing column 44 of the screw 40 is fixed within the mounting hole 266 of the fastener 20. The second mounting part 30 is located between the resisting portion 262 and the second operation end 42. The first mounting part 10 and the second mounting part 30 are located on opposite ends of the resisting portion 262. The first mounting part 10 and the second mounting part 30 are planar. The first mounting part 10 is substantially parallel to the second mounting part 30. A distance between the first mounting part 10 and the second mounting part 30 is equal to a height of the resisting portion 262.

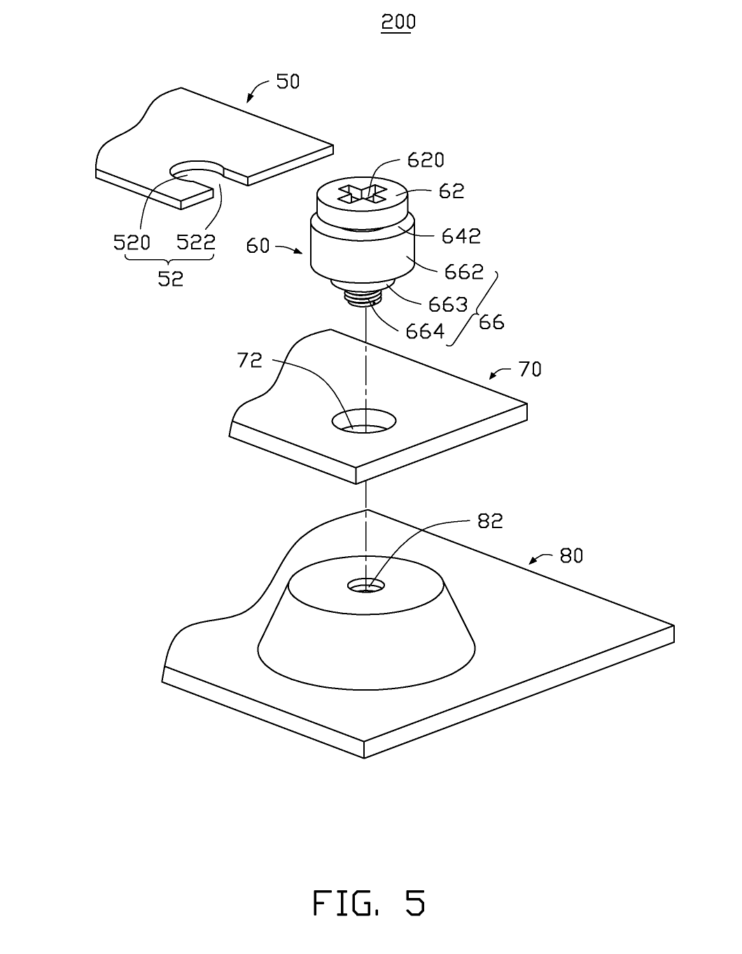

FIG. 5 illustrates another embodiment of a fixing assembly 200 for fixing and spacing circuit boards. The fixing assembly 200 includes a first mounting part 50, a fastener 60, a second mounting part 70, and a screw 80.

The first mounting part 50 defines a connecting portion 52. In at least one embodiment, the connecting portion 52 is located at an edge of the first mounting part 50. The connecting portion 52 defines a connecting hole 520 and a guide groove 522. The connecting hole 520 communicates with the guide groove 522. In this embodiment, the connecting hole 520 is substantially arc-shaped and the guide groove 522 is substantially rectangular. A width of the guide groove 522 is less than a diameter of the connecting hole 520. The guide groove 522 extends to the edge of the first mounting part 50.

The fastener 60 includes a first operation end 62, a stopper portion 64, and a fixing end 66. The stopper portion 64 extends from the first operation end 62. The fixing end 66 extends from the stopper portion 64. The stopper portion 64 is located between the first operation end 62 and the fixing end 66. The first operation end 62 defines a first operation part 620. In this embodiment, the first operation part 620 is cross-shaped. The first operation end 62, the stopper portion 64, and the fixing end 66 are substantially cylindrical. A diameter of the stopper portion 64 is less than diameters of the first operation end 62 and the fixing end 66, to form a latching slot 642. The stopper portion 64 can be elastic. The diameter of the stopper portion 64 is less than the diameter of the connecting hole 520 but greater than the width of the guide groove 522. The fixing end 66 includes a resisting portion 662, a positioning column 663, and a fixing part 664. The positioning column 663 extends from the resisting portion 662. The fixing part 664 extends from the positioning column 663. In at least one embodiment, the resisting portion 662, the positioning column 663, and the fixing part 664 are substantially cylindrical. A diameter of the fixing part 664 and the positioning column 663 is less than a diameter of the resisting portion 662. The fixing part 664 can include an external thread. The fastener 60 is integrally formed.

The second mounting part 70 defines a hole 72. A diameter of the hole 72 is at least equal to the diameter of the positioning column 663. The diameter of the hole 72 is less than the diameter of the resisting portion 662.

The screw 80 defines a locking hole 82. The locking hole 82 is a threaded hole.

The screw 80 can be a third mounting part.

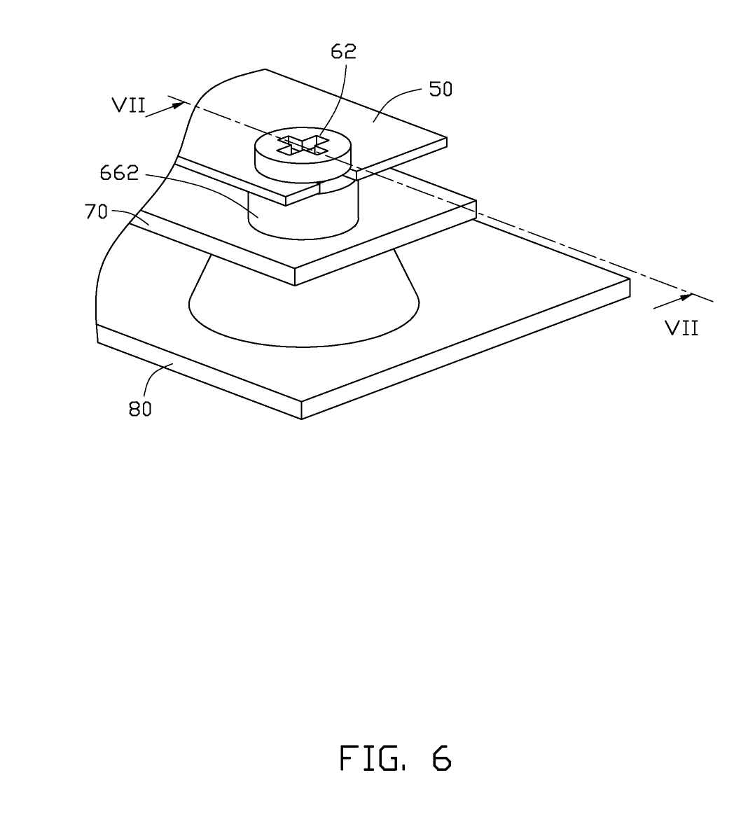

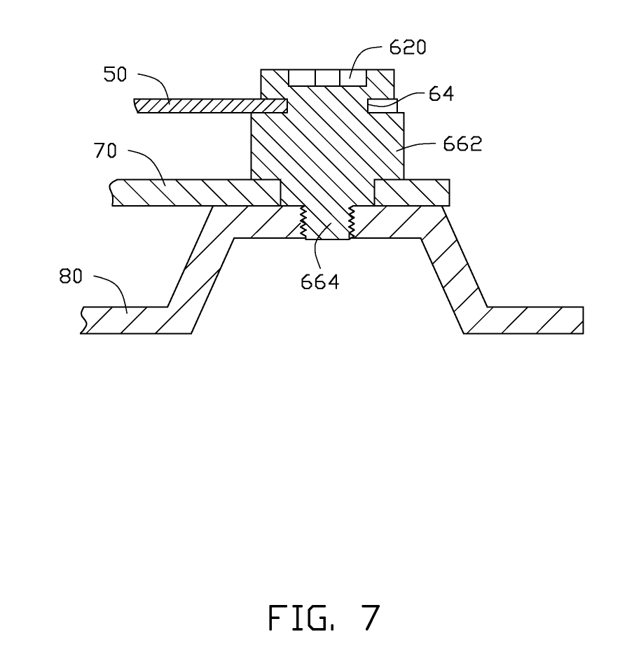

FIGS. 6 and 7 show two views of the assembled fixing assembly 200. In assembly, the stopper portion 64 of the fastener 60 slides into the connecting hole 520 from the guide groove 522 of the first mounting part 50. The stopper portion 64 is squeezed by the edge of the guide groove 522 because the diameter of the stopper portion 64 is greater than the width of the guide groove 522. The stopper portion 64 restores to full size in the connecting hole 520 because the diameter of the stopper portion 64 is less than the diameter of the connecting hole 520. The first mounting part 50 is mounted in the latching slot 642 of the fastener 60. The fixing part 664 of the fastener 60 extends through the hole 72 of the second mounting part 70 and is fixed in the locking hole 82.

The embodiments shown and described above are only examples. Many details are often found in the art such as the other features of a fixing assembly. Therefore, many such details are neither shown nor described. Even though numerous characteristics and advantages of the present technology have been set forth in the foregoing description, together with details of the structure and function of the present disclosure, the disclosure is illustrative only, and changes may be made in the details, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A fixing assembly comprising:
a first mounting part defining a connecting portion;
a second mounting part defining a hole;
a fastener comprising a stopper portion and a fixing end, the fixing end extending from the stopper portion, and the fixing end comprising a resisting portion and a fixing part; and
a screw;
wherein the stopper portion is configured to be received in the connecting portion of the first mounting part; the fixing part extends through the hole and is locked with the screw; and the first mounting part and the second mounting part are located on opposite ends of the resisting portion.

2. The fixing assembly of claim 1, wherein the connecting portion defines a connecting hole and a guide groove; the connecting hole communicates with the guide groove; and the guide groove extends to an edge of the first mounting part.

3. The fixing assembly of claim 2, wherein the connecting hole is substantially arc-shaped; the guide groove is substantially rectangular; and a width of the guide groove is less than a diameter of the connecting hole.

4. The fixing assembly of claim 3, wherein the stopper portion is substantially cylindrical; a diameter of the stopper portion is less than the diameter of the connecting hole but greater than the width of the guide groove.

5. The fixing assembly of claim 1, wherein the fixing end further defines a mounting hole; the mounting hole extends from the fixing part to an interior of the resisting portion; the mounting hole is a threaded hole; the screw comprises a fixing column; the fixing column comprises an external thread; and the fixing column is fixed within the mounting hole.

6. The fixing assembly of claim 1, wherein the fixing part is substantially cylindrical; the fixing part comprises an external thread; the screw defines a locking hole; the locking hole is a threaded hole; the fixing part is fixed within the mounting hole; and the second mounting part is fixed with the fastener.

7. The fixing assembly of claim 1, wherein the first mounting part and the second mounting part are planar; and the first mounting part is substantially parallel to the second mounting part.

8. The fixing assembly of claim 7, wherein a distance between the first mounting part and the second mounting part is equal to a height of the resisting portion.

9. The fixing assembly of claim 1, wherein the fastener is integrally formed.

10. A fixing device for fixing a first mounting part and a second mounting part; the second mounting part defining a hole; the fixing assembly comprising:
a fastener comprising a stopper portion and a fixing end, the fixing end extending from the stopper portion, and the fixing end comprising a resisting portion and a fixing part; and
a screw;
wherein the stopper portion is configured to be received in the first mounting part; the fixing part extends through the hole and is locked with the screw; and the first mounting part and the second mounting part are located on two opposite ends of the resisting portion.

11. The fixing device of claim 10, wherein the fixing end further defines a mounting hole; the mounting hole extends from the fixing part to an interior of the resisting portion; the mounting hole is a screw hole; the screw comprises a fixing column; the fixing column comprises an external thread; and the fixing column is fixed within the mounting hole.

12. The fixing device of claim 10, wherein the fixing part is substantially cylindrical; the fixing part comprises an external thread; the screw defines a locking hole; the locking hole is a screw hole; the fixing part is fixed within the mounting hole; and the second mounting part is fixed with the fastener.

13. The fixing device of claim 10, wherein the fastener is integrally formed.

14. A fixing assembly comprising;
a first mounting part defining a connecting portion;
a second mounting part;
a fastener comprising a stopper portion and a fixing end, the fixing end extending from the stopper portion, and the fixing end comprising a resisting portion and a fixing part; and
a screw;
wherein the stopper portion is configured to be received in the connecting portion of the first mounting part; the fixing part is locked with the screw; and the first mounting part and the second mounting part are located on two opposite ends of the resisting portion.

15. The fixing assembly of claim 14, wherein the connecting portion defines a connecting hole and a guide groove; the connecting hole communicates with the guide groove; and the guide groove extends to an edge of the first mounting part.

16. The fixing assembly of claim 15, wherein the connecting hole is substantially arc-shaped; the guide groove is substantially rectangular; and a width of the guide groove is less than a diameter of the connecting hole.

17. The fixing assembly of claim 16, wherein the stopper portion is substantially cylindrical; and a diameter of the stopper portion is less than the diameter of the connecting hole and is greater than the width of the guide groove.

18. The fixing assembly of claim 14, wherein the fixing end further defines a mounting hole; the mounting hole extends from the fixing part to an interior of the resisting portion; the mounting hole is a screw hole; the screw comprises a fixing column; the fixing column can comprises an external thread; and the fixing column is fixed within the mounting hole.

19. The fixing assembly of claim 14, wherein the fixing part is substantially cylindrical; the fixing part comprises an external thread; the screw defines a locking hole; the locking hole is a threaded hole; the fixing part is fixed within the mounting hole; and the second mounting part is fixed with the fastener.

20. The fixing assembly of claim 14, wherein the first mounting part and the second mounting part are planar; and the first mounting part is substantially parallel to the second mounting part.
